(19) United States
(12) Patent Application Publication
(10) Pub. No.: US 2025/0165916 A1
(43) Pub. Date: May 22, 2025

(54) SECURE PACKAGE DELIVERY WITHOUT A TARGET RECIPIENT

(71) Applicant: Motorola Mobility LLC, Chicago, IL (US)

(72) Inventors: Krishnan Raghavan, Bangalore (IN); Nakul Patel, Bangalore (IN); Vignesh Karthik Mohan, Bangalore (IN)

(73) Assignee: Motorola Mobility LLC, Chicago, IL (US)

(21) Appl. No.: 18/517,337

(22) Filed: Nov. 22, 2023

(51) Int. Cl. G06Q 10/083

(52) U.S. Cl. CPC G06Q 10/0838

(57) ABSTRACT

In aspects of secure package delivery without a target recipient, a server device receives a request for a security code for validating a package delivery to a target user. The server device obtains location information indicating an availability status of the target user to receive the package delivery. The server device transmits the security code to a client device of the target user if the location information indicates that the target user is available to receive the delivery of the package. The client device of the target user can analyze the location information and forward the security code to an alternate client device if the user is unavailable to receive the delivery of the package. The server device transmits the security code to one or more alternate client devices of alternate users on a list of authorized users if the location information indicates that the target user is unavailable.

### BACKGROUND

Devices, such as smart devices, mobile devices (e.g., cellular phones, tablet devices, smartphones), consumer electronics, and the like, can be implemented for use in a wide range of environments and for a variety of different applications. For example, a device can implement a marketplace application that allows a user to purchase items. The marketplace application can include a user interface for displaying products to the user. The user may interact with the user interface to purchase products for delivery or pickup, to return products that were previously purchased, to receive personalized product recommendations, to receive notifications related to the marketplace application, and more. Packages ordered by the user may be delivered to a physical location, such as to a place of residence of the user.

### BRIEF DESCRIPTION OF THE DRAWINGS

Implementations of the techniques for secure package delivery without a target recipient are described with reference to the following Figures. The same numbers may be used throughout to reference like features and components shown in the Figures:

FIGS. 1 and 2 illustrate example systems for secure package delivery without a target recipient in accordance with one or more implementations as described herein.

FIGS. 3 and 4 illustrate example graphical user interfaces (GUIs), which support secure package delivery without a target recipient in accordance with one or more implementations as described herein.

FIG. 5 illustrates an example process flow, which supports secure package delivery without a target recipient in accordance with one or more implementations as described herein.

FIGS. 6 and 7 illustrate example methods for secure package delivery without a target recipient in accordance with one or more implementations of the techniques described herein.

FIG. 8 illustrates various components of an example device that can be used to implement the techniques for secure package delivery without a target recipient as described herein.

### DETAILED DESCRIPTION

Implementations of techniques for secure package delivery without a target recipient are described herein. In some examples, a user may order a product from an online marketplace. A delivery service may deliver a package including the product to a physical location of the user. For example, the user may specify a delivery location (e.g., address) and a delivery date when purchasing a product from the online marketplace. A delivery agent of the delivery service may deliver the package to the specified delivery location on the delivery date. In some examples, the delivery location may not be secure, so the delivery agent may wait to deliver the package until a user is available to receive the package at the physical location. However, the delivery agent may be unable to verify that the user at the physical location is a user who is authorized to receive the delivery, causing security risks due to potentially delivering the package to a malicious actor as well as potential delays due to delivery to incorrect recipients. Additionally, or alternatively, the delivery service may incorrectly mark the package as delivered.

Thus, conventional techniques to reduce or prevent delivery to incorrect users and to prevent the delivery service from incorrectly marking a package as delivered, involve implementing a security code (e.g., a one-time password (OTP)). The delivery service can send the security code to the client device of the intended user for the delivery of the package. Similarly, the delivery service can send a corresponding security code to a device of a delivery agent performing the delivery of the package. If the user is at the physical location of the delivery, the user may provide the security code to the delivery agent. The delivery agent can compare the security code provided by the user to the corresponding security code received at the device of the delivery agent. If the security codes match, the delivery agent may securely deliver the package to the intended user. If the security codes do not match, the delivery agent may not deliver the package to the user and may wait until the user provides a security code that matches. However, if the intended user is not at the physical location when the delivery agent is attempting to deliver the package, the user may not be able to provide the security code. The delivery agent may not deliver the package, causing inefficient use of time of the delivery agent and high operating cost for the delivery service, as well as delays in package delivery for the user.

As described herein, a server device of the delivery service and/or a device of a user can determine that a user is not at a physical location to receive a delivery of a package and can forward a security code to a device of an alternate trusted user. For example, a user may configure a list of trusted users that are authorized to receive a delivery of a package. In some other examples, a server device or a mobile device of a user can determine a list of trusted users from delivery history for the user or delivery history related to packages delivered to the physical location. The server device can acquire location information indicating an availability status of the user to receive a scheduled package delivery from a delivery service (e.g., application data, location data, and/or system data of the device indicating the user is not available or away from the physical location). If the intended or target user is at the physical location, then the server device sends the security code to the device of the target user. If the target user is not at the physical location, then the server device selects a device of an alternate user from the list of trusted users to send the security code to. In some cases, the server device transmits the security code to the device of the target user incorrectly (e.g., when the user is not at the physical location or when the user is busy) due to outdated or incorrect location information, and the device of the intended user selects a device of an alternate user from the list of trusted users to forward the security code to. The server device and/or the device of the intended user can analyze location information of the devices of the trusted users to select an alternate user who is at the physical location.

While features and concepts of the described techniques for secure package delivery without a target recipient can be implemented in any number of different devices, systems, environments, and/or configurations, implementations of the techniques for secure package delivery without a target recipient are described in the context of the following example systems, user interfaces, process flows, methods, and devices.

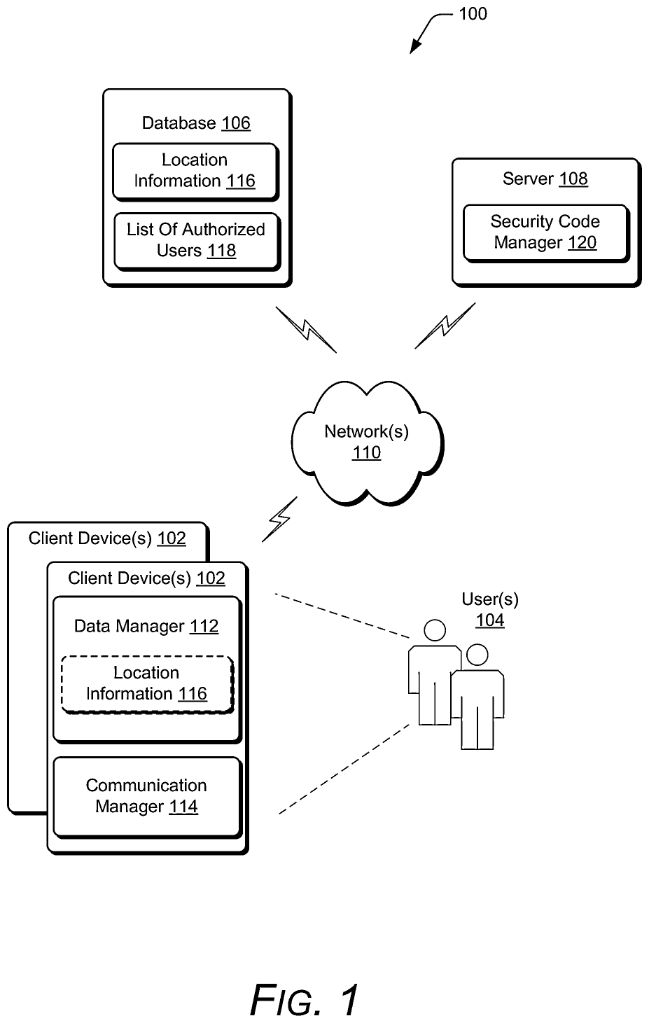

FIG. 1 illustrates an example system 100 for secure package delivery without a target recipient, as described herein. The example system 100 includes one or more client devices 102, one or more users 104 of the client devices 102, a database 106, and a server 108, where the client devices 102, the database 106, and the server 108 are interconnectable via one or more networks 110. In some examples, the client devices 102 include a smartphone, mobile phone, and/or any other type of wireless device or mobile device. The client devices 102 can be implemented with various components, such as a processor system and memory, as well as any number and combination of different components as further described with reference to the example device shown in FIG. 8. In implementations, the client device 102 includes various radios for wireless communication with other devices (e.g., via the networks 110). For example, the client device 102 may include a Bluetooth (BT) and/or Bluetooth Low Energy (BLE) transceiver and/or a near field communication (NFC) transceiver. The client device 102 can also include a Wi-Fi radio, a global positioning system (GPS) radio, and/or any type of device communication interfaces.

The client devices 102 includes various functionality that enables the client devices 102 to perform different aspects of secure package delivery without a target recipient, as discussed herein, including a data manager 112 and a communication manager 114. The data manager 112 represents functionality (e.g., logic and hardware) for enabling the client device 102 to collect location information 116 related to a geographic location of a user 104 of the client device 102 and/or related to an availability status of the user 104 of the client device 102 to receive a delivery of a package. The data manager 112 collects application data, system data, and/or geographic data to determine the location information 116. For example, the data manager 112 collects data from one or more of a scheduling application that tracks a calendar or schedule of the user 104, a tracking application that includes a geographical location of the user 104, applications that allow a user to tag a location, or messaging applications that include data related to travel plans or location of the user, among others. Additionally, or alternatively, the data manager 112 collects system information related to a client device 102 of a user 104, the system information including one or more of an airplane mode status of the client device 102 or a network connectivity status of the client device 102, among other settings that can indicate a location of the user 104 and/or an availability status of the user 104 (e.g., whether the user is busy in a meeting, on a plane, etc.). Additionally, or alternatively, the data manager 112 collects GPS data indicating the location of the client device 102. For example, a user may enable one or more applications or services at the client device 102 that enable the client device 102 to track a geographical location or availability status.

The communication manager 114 represents functionality (e.g., logic and hardware) for enabling the client device 102 to interconnect with other devices and/or networks, such as the networks 110. The communication manager 114, for instance, enables wireless and/or wired connectivity of the client device 102. For example, the communication manager 114 represents one or more antennas for transmitting and receiving signaling from other devices via the networks 110.

The networks 110 can include computer networks and/or telecommunication networks. For example, the networks 110 include a wireless local area network (WLAN), a wireless network, a BT network, a cellular network, a satellite network, and/or a fiber optic network. The networks 110 connect one or more devices, such as the server 108, the database 106, and one or more client devices 102, among others.

The database 106 stores data for one or more devices. For example, the database 106 stores the location information 116 collected by the one or more client devices 102 and/or the server 108. Additionally, or alternatively, the database 106 stores a list of authorized users 118, which includes one or more users 104 indicated to be trusted to receive a package delivery. The database 106 is an example of a remote database (e.g., cloud or network-based database), a physical database, or the like. In some examples, the database 106 can be hosted at a client device 102, which is an example of a local database. The client device 102 can store the location information 116 and/or a list of authorized users 118 at the local database. In some other examples, the client device 102 connects to a remote database, or cloud database, to store the location information 116 and/or the list of authorized users 118, among other data. Additionally, or alternatively, the server 108 may host the database 106, may connect to a remote database (e.g., via the networks 110), or both, to access the location information 116 and/or the list of authorized users 118.

The server 108 provides a secure package delivery service to the one or more client devices 102. In some examples, the server 108 is one or more of a web server, an application server, or a cloud server, among others. The server 108 includes various functionality that enables a client device 102 to perform different aspects of secure package delivery without a target recipient discussed herein, including a security code manager 120. The security code manager 120 represents functionality (e.g., logic and hardware) for enabling the server 108 to generate security codes for secure package delivery. For example, the security code manager 120 implements a random code generator to select one or more values for an OTP, or other security code, where each generated security code is unique. In some examples, the security code includes a time-based OTP, a counter based OTP, a mobile authenticator security code, a message-based security code, or any other security code.

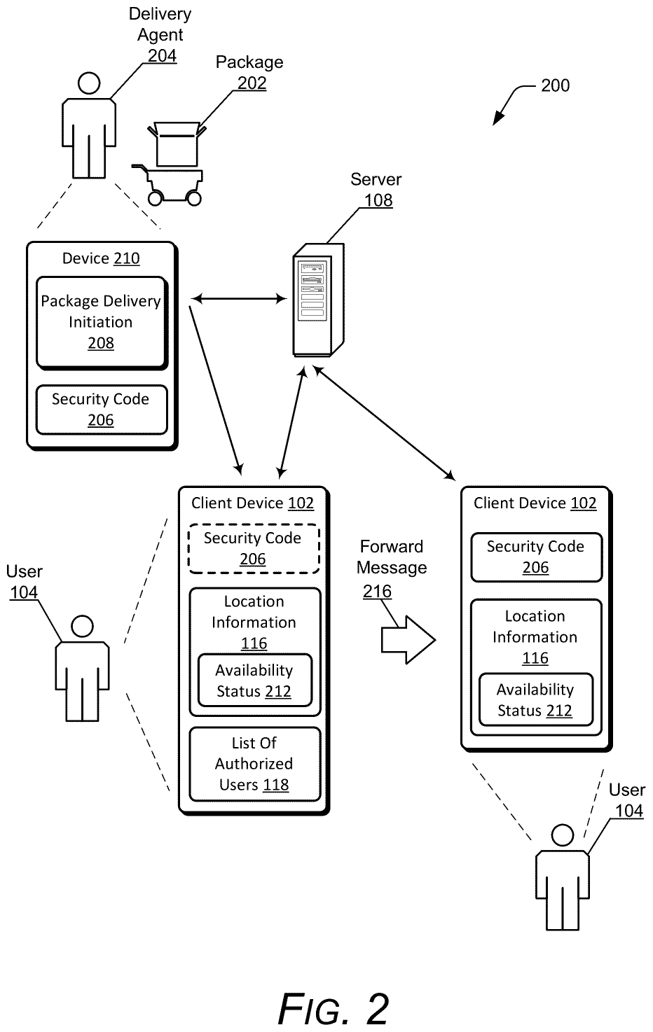

In some examples, the security code is intended for a one-time use and is valid for a specified duration (e.g., a temporary security code). The server 108 can generate a security code using the security code manager 120 if a delivery service is attempting to deliver a package to a target, or intended, user 104. The server 108 can access the location information 116 and a list of authorized users 118 from the database 106 (e.g., via the networks 110 if the database 106 is a remote database) to determine whether the client device 102 of the target user 104 is at a geographical location specified by the delivery service. Additionally, or alternatively, the server 108 can communicate directly with the client devices 102 (e.g., via the networks 110) to access the location information 116 and/or the list of authorized users 118, such as if the location information 116 and/or the list of authorized users 118 is stored at a local database at a client device 102 or at a local database at the server 108. If the target user 104 is at the geographical location, then the server 108 sends the generated security code to the client device 102 of the target user 104. If the target user 104 is not at the geographic location, then the server 108 sends the generated security code to an alternate client device 102 of a user 104 on a list of authorized users 118, which is described in further detail with respect to FIG. 2.

In some examples, the users 104 may represent users 104 on an authorized, or trusted, list of users 104 (e.g., on the list of authorized users 118 stored at the database 106). A user 104 of a client device 102 may specify a list of users authorized to receive a delivery of a package for the user 104. In some examples, a user 104 of a client device 102 may also specify a priority order along with the list of users authorized to receive a delivery of a package for the user 104. For example, the user 104 may specify the list of authorized users 118 via a GUI, or other user interface, of the client device 102. Additionally, or alternatively, the client device 102, the server 108, or both can autonomously determine the list of authorized users 118 (e.g., independent of user input), such as by analyzing historical delivery information or data to detect additional users 104 at a delivery location. For example, the historical delivery information can include one or more of a list of previous users 104 who received packages delivered to a target address or location or historical user input indicating a list of authorized users 118 (e.g., that are authorized to receive packages at the target address or location), among other data. The list of authorized users 118 can be stored at the database 106.

FIG. 2 illustrates an example system 200 for secure package delivery without a target recipient in accordance with one or more implementations as described herein. The example system 200 may implement aspects of the example system 100 described with reference to FIG. 1. The example system 200 may include one or more client devices 102, one or more users 104, and a server 108, which are examples of the corresponding features as described with reference to FIG. 1. Although a database 106 and one or more networks 110 are not illustrated in the example system 200, the server 108 and/or the client devices 102 can implement one or more databases 106 and can be connected via one or more networks 110, as described with reference to FIG. 1.

In some examples, the client device 102 is configured to run one or more applications. The client device 102 has a GUI that displays an application to a user 104, and the user interacts with the application via the GUI. The applications can include online marketplace applications that display products to a user 104 (e.g., fashion products, appliances, home decor, books, etc.). The user 104 can purchase the products by interacting with the online marketplace application. During the purchase process for purchasing the product, the online marketplace application prompts the user 104 to input delivery information for the product. In some cases, the online marketplace application also prompts the user 104 to provide a delivery date and time. In some other cases, the online marketplace application selects a delivery date and time according to delivery criteria provided by a delivery service (e.g., earliest delivery date, delivery method, and the like). The online marketplace that operates the online marketplace application coordinates with a delivery service to deliver a package 202 that includes the product.

In some examples, the delivery service includes one or more delivery agents 204 that are responsible for delivering the package 202. In some cases, the delivery agents 204 include one or more people hired to deliver the package 202, devices or machines configured to deliver the package 202 (e.g., drone delivery, autonomous vehicle delivery, or delivery by another device or machine), or both. It is to be appreciated that the delivery agent 204 can be a human delivery agent or a non-human delivery agent. In some examples, the delivery service provides the delivery agent 204 with an address to a physical location to deliver the package 202, where the address is specified by the user 104 via the online marketplace application.

In some examples, the delivery agent 204 may wait to deliver the package 202 until a target user 104 is available to receive the package 202 at the physical location. However, the delivery agent 204 may be unable to verify that the user 104 at the physical location is a user 104 who is authorized to receive the delivery, causing security risks due to potentially delivering the package 202 to a malicious actor as well as potential delays due to delivery to incorrect recipients. Additionally, or alternatively, the delivery service may incorrectly mark the package as delivered.

Thus, to reduce or prevent delivery to incorrect users 104 and to prevent the delivery agent 204 from incorrectly marking the package 202 as delivered, the delivery service can implement a security code 206 for delivery of the package 202. The delivery service can send the security code 206 to the client device 102 of the intended user 104 for the delivery of the package 202. For example, a server 108 providing the delivery service can send a security code 206 to the client device 102 via one or more networks 110, as described with reference to FIG. 1.

In some cases, the delivery agent 204 may perform a package delivery initiation 208 at a device 210 of the delivery agent 204. The device 210 can be an example of a client device 102 as described with reference to FIG. 1 or any other device. In some examples, the device 210 is coupled (e.g., via a wireless connection) to the server 108. Additionally, or alternatively, the device 210 hosts the server 108. The package delivery initiation 208 can include input from the delivery agent 204 via the device 210, such as a delivery agent 204 inputting string data, pushing a physical or displayed button on the device 210, or the like that initiates delivery of the package 202 to the user 104. In some examples, the delivery of the package 202 is initiated based on delivery information collected at different instances in the delivery process. For example, a delivery agent 204 or other agent from the delivery service can scan the package 202, via a barcode, a QR code, or any other means, to indicate to the delivery service the delivery information about the status of the delivery process, the location of the package 202, or other information related to the delivery of the package 202. The delivery agent 204 scanning the package can initiate delivery of the package 202.

In some cases, the server 108 receives a request for the security code 206 after the package delivery initiation 208 (e.g., from the device 210 and/or from the client device 102). The server 108 sends a security code 206 to the device 210 and to the client device 102. The security code 206 is valid for a specified duration, such as until the end of a delivery period for the delivery agent 204, a defined numerical quantity of hours, minutes, and/or days, or the like. The server 108 sends the security code 206 to the client device 102 of the target user 104 and a corresponding security code 206 (e.g., a same security code 206) to the device 210. In some examples, such as if the server 108 is hosted by the delivery service, the server 108 sends the security code 206 to the device 210, and the device 210 sends the security code 206 to the client device 102. If the target user 104 (e.g., the user 104 indicated in the address input to the online marketplace application) is at the physical location of the delivery, the target user 104 may provide the security code 206 to the delivery agent 204. The delivery agent 204 can compare the security code 206 provided by the user 104 to the corresponding security code 206 at the device 210 of the delivery agent 204. If the security codes 206 match, the delivery agent 204 may securely deliver the package 202 to the user 104 (e.g., a target user 104) and mark the package 202 as delivered in a delivery service system. If the security codes 206 do not match, the delivery agent 204 may not deliver the package 202 to the user 104 and may wait until the user 104 provides a security code 206 that matches.

However, if the target user 104 is not at the physical location when the delivery agent 204 is attempting to deliver the package 202, then the user 104 may not be able to provide the security code 206. For example, if the target user 104 is at a work address and the delivery address is a home address, then the delivery agent 204 may not deliver the package 202. Additionally, or alternatively, an alternate user 104 (e.g., a cohabitant of the target user 104) may be at the physical location, but the alternate user 104 may not have access to the security code 206. The availability of the target user 104 to receive the package 202 at the physical location specified in the address is referred to as an availability status 212. For example, the user 104 is unavailable if the user 104 is not at the physical address and/or is busy, and the user 104 is available if the user is at the physical address and not busy. The delivery agent 204 failing to deliver the package causes inefficient use of time for the deliver agent 204 and high operating cost for the delivery service, as well as delays in delivery of the package 202 for the target user 104. Failing to deliver the package 202 also causes inefficient use of computational resources due to regenerating the security code 206 if the package 202 is not delivered prior to expiration of the security code 206 after the specified duration. Further, the cohabitants of the target user 104 may request the security code 206 from the target user 104, which is time consuming for the target user 104 and the cohabitants and negatively impacts user experience related to the delivery service and the online marketplace application.

In some examples, a target user 104 may order a product (e.g., a household item) from an online marketplace application and may select a home address for delivery of the household item. The target user 104 may go into work on the selected delivery day and may become busy and/or may silence or turn off notifications at a client device 102 of the target user 104. The delivery agent 204 may arrive at the home address for delivery of the package 202 including the household item and may ask cohabitants of the target user 104 for a security code to securely deliver the package 202 (e.g., a spouse, children, roommate, etc.). However, the cohabitant may be unable to reach the target user 104 due to the target user 104 being busy and/or not receiving notifications at the client device 102. Thus, the delivery agent 204 may not deliver the package 202, causing delay in delivery of the household item and negatively impacting the user experience of the delivery service and the online marketplace application for the target user 104, the cohabitant, or both.

In some other examples, a target user 104 may order a product or item from an online marketplace application that has a relatively high monetary value, such as jewelry. Due to the monetary value exceeding a threshold value, the online marketplace application enables a security code 206 for the delivery of a package 202 including the high value product. The target user 104 may receive the security code 206 when the delivery agent 204 arrives at the physical location specified by the target user 104 via the online marketplace application. The target user 104 may manually forward the security code from a client device 102 of the target user 104 to a client device 102 of an alternate user 104, such as a user 104 who is expected to be at the physical location. However, the target user 104 and the alternate user 104 may not be at the physical location, and the deliver agent 204 may not deliver the package 202 (e.g., the jewelry), causing delay in delivery of the package 202 and negatively impacting the user experience of the delivery service and the online marketplace application for the target user 104, the alternate user 104, or both.

To securely deliver the package 202 to a target user 104 or an alternate user 104 who is at a physical location specified for delivery of the package 202, the delivery service analyzes location information 116 of one or more users 104 authorized to receive the package 202. The location information 116 is an example of the location information 116 as described with reference to FIG. 1 and includes one or more of application data, geographical location information, and/or system information for the one or more client devices 102. The location information 116 indicates an availability status 212 of a user 104 of the client device 102. For example, if the location information 116 indicates that the user 104 of the client device 102 is at the physical location specified for the delivery and is available to receive the package 202, the availability status 212 of the user 104 of the client device 102 is available to receive the delivery. The location information 116 can also include an indication of whether the client device 102 is receiving notifications (e.g., whether the client device 102 is in an airplane mode or not within a coverage area of a network 110). If the client device 102 is not receiving notifications or is otherwise busy and/or if the client device 102 is not at the physical location specified for the delivery, the availability status 212 of the user 104 of the client device 102 is unavailable to receive the delivery.

When the target user 104 is unavailable, the client device 102 and/or the server 108 can determine an alternate user 104 using location information 116 for respective users 104 on a list of authorized users 118. In some examples, the target user 104 specifies the list of authorized users 118 or trusted users prior to the package delivery initiation 208. For example, the target user 104 can specify the list of authorized users 118 when the target user 104 sets up an account for the online marketplace application, when the target user 104 places an order for a product, or at any other time prior to the package delivery initiation 208. The client device 102 can communicate the list of authorized users 118 to the server 108 and/or to the client devices 102 of the users 104 on the list of authorized users 118 (e.g., by storing the list in a database 106 that can be accessed by the server 108 and/or the client devices 102). In some other examples, the client device 102 of the target user 104, the client devices 102 of the users 104 on the list of authorized users 118, and/or the server 108 determines the list of authorized users 118 or trusted users independent from the target user 104 (e.g., without the target user 104 specifying the list of authorized users 118).

The client device 102 of the target user 104, the client devices 102 of the users 104 on the list of authorized users 118, and/or the server 108 can access historical data related to packages 202 previously delivered to the physical location indicated by the target user 104. For example, there may be one or more packages 202 that were delivered to a same address specified by the target user 104, but delivered to different users 104. Additionally, or alternatively, the client device 102 of the target user 104, the client devices 102 of the users 104 on the list of authorized users 118, and/or the server 108 can access application data related to authorized users 104 to determine the list of authorized users 118 (e.g., a family application, a mapping application, a social network application, etc.). The client device 102 of the target user 104, the client devices 102 of the users 104 on the list of authorized users 118, and/or the server 108 can specify the different users 104 as authorized users, which can be authenticated by a target user 104.

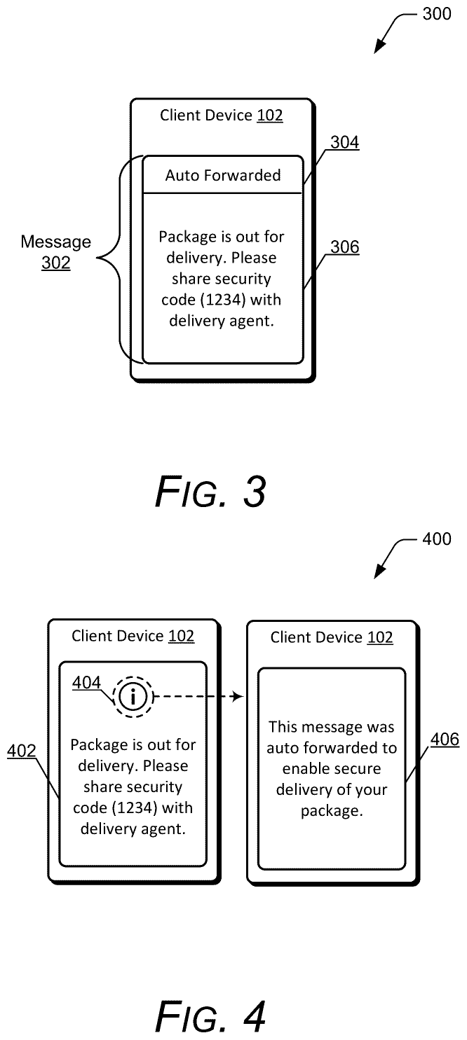

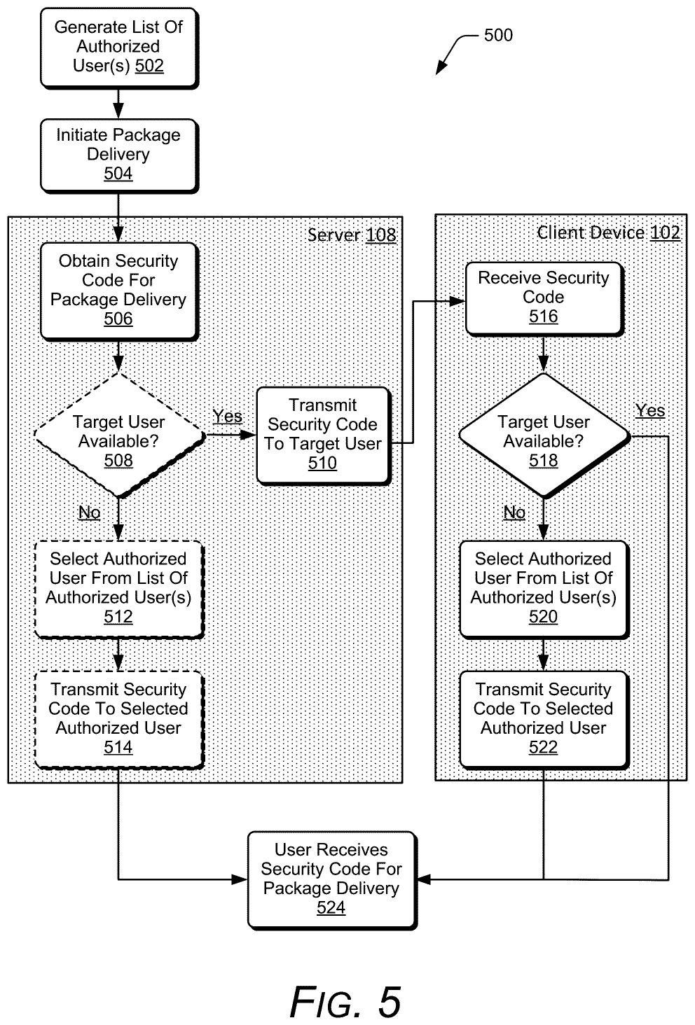

In some examples, the server 108 accesses a database 106 to obtain location information 116 for the target user 104 and/or location information 116 for the client device 102 of the target user 104. Additionally, or alternatively, the server 108 accesses the database 106 to obtain location information 116 for the users 104 on the list of authorized users 118 and/or location information 116 for the client devices 102 of the users 104 on the list of authorized users 118. If the location information 116 of the client device 102 of the target user 104 and/or of the client device 102 indicates that the target user 104 is not available to receive a package delivery, then the server 108 sends the security code directly to one or more alternate client devices 102 of users 104 that are available to receive the package 202 at the physical location. The server 108 analyzes location information 116 for respective users 104 on the list of authorized users 118 and/or user devices 102 of the respective users 104 on the list of authorized users 118 to determine which users 104 on the list are available to receive the package 202. The server 108 can send the security code to a client device 102 of one alternate user 104 or to client devices 102 of multiple alternate users 104 (e.g., each of the available users 104). The client devices 102 of the alternate users 104 can display or present a message on a GUI of a respective client device 102, which is described in further detail with respect to FIGS. 3 and 4.

In some other examples, the server 108 accesses the database 106 to obtain location information 116 for the target user 104 and/or a client device 102 of the target user 104 and determines that the location information 116 indicates that the target user 104 is available (e.g., is at the physical location to receive the package 202 and not in a meeting or otherwise unavailable). The server 108 sends the security code to the client device 102 of the target user 104. The client device 102 can have additional location information 116 and/or more recent location information 116 that the server 108 may not have access to. Therefore, the client device 102 of the target user 104 can perform an additional analysis to determine whether the target user 104 is available to receive the delivery of the package 202. If the client device 102 detects that the target user 104 is not available (e.g., not at the delivery location or otherwise busy), then the client device 102 forwards the message including the security code to an alternate client device 102, at 216. For example, at 216, the client device 102 of a target user 104 forwards a message including the security code to one or multiple client devices 102 on the list of authorized users 118. The client device 102 that receives the forwarded message can perform an additional analysis to determine whether the alternate user 104 is available to receive the delivery of the package 202. If a user 104 of an alternate client device 102 is available to receive the delivery of the package 202, then the client device 102 of the available alternate user 104 displays a message to the alternate user 104 who indicates the security code, as described in further detail with respect to FIGS. 3 and 4. If a user 104 of the alternate client device 102 is unavailable to receive the delivery of the package 202, then the client device 102 of the unavailable user 104 forwards the message to a client device 102 of a user 104 on the list of authorized users 118 that is available to receive the delivery of the package 202.

In some examples, if multiple alternate users 104 are available to receive the package, then the server 108 and/or a client device 102 can select a client device 102 from the list of authorized users 118 and/or a list of authorized devices according to a priority assigned to each user and/or device on the list. For example, each user and/or device on the list of authorized users 118 and/or the list of authorized devices can be assigned a priority when added to the list. The server 108 and/or the client device 102 can compare the priorities of the multiple alternate users 104 on the list of authorized users 118 and/or the list of authorized devices that are available to receive the package and select one or more authorized users and/or authorized devices that are available to receive the package and have a relatively high priority (e.g., a highest priority). The server 108 and/or the client device 102 can send the security code to client devices 102 of the selected authorized users and/or to the selected authorized devices.

FIG. 3 illustrates an example GUI 300, which supports secure package delivery without a target recipient in accordance with one or more implementations as described herein. The example GUI 300 may implement aspects of the example system 100, as well as the example system 200 as shown and described with reference to FIGS. 1 and 2. For example, the example GUI 300 may illustrate an example of a message displayed at a client device of an alternate user 104 who is forwarded the message from a client device 102 of a target user 104 or from the server 108. The client device 102 is an example of a client device 102 as described with reference to FIGS. 1 and 2.

In the example GUI 300, a client device 102 displays a message 302 for a user 104 of the client device 102 to view. The client device 102 can alert the user 104 of the message 302, such as by an audio alert, a visual alert, a haptic alert, or any other type of alert. In some examples, the message 302 includes a header 304 that indicates to the user 104 of the client device 102 that the message 302 has been auto forwarded by the server 108 and/or by a different client device 102.

In some examples, the message 302 includes text 306 that indicates a security code 206 to a user 104 for receiving a delivery of a package 202, where the security code 206 and the package 202 are examples of the corresponding features as described with reference to FIG. 2. For example, the text 306 can include “Package is out for delivery. Please share security code (1234) with delivery agent.” The text 306 can be any variation of text that displays the security code 206 (e.g., 1234). The message 302 can request user input from the user 104, such as an acknowledgement of the message 302 (e.g., via buttons). The user 104 can provide the security code 206 to a delivery agent 204, as described with reference to FIG. 2.

FIG. 4 further illustrates an example GUI 400, which supports secure package delivery without a target recipient in accordance with one or more implementations as described herein. The example GUI 400 may implement aspects of the example system 100, as well as the example system 200 and/or the GUI 300 as shown and described with reference to FIGS. 1 through 3. For example, the example GUI 400 may illustrate an example of a message displayed at a client device of an alternate user 104 who is forwarded the message from a client device 102 of a target user 104 or from a server 108. The client device 102 is an example of a client device 102 as described with reference to FIGS. 1 and 2.

In the example GUI 400, a client device 102 displays a message 402 for a user 104 of the client device 102 to view. The client device 102 can alert the user 104 of the message 402, such as by an audio alert, a visual alert, a haptic alert, or any other type of alert. In some examples, the message 402 includes an interactive icon 404. If the user 104 of the client device 102 interacts with the interactive icon 404 (e.g., by hovering over the interactive icon 404, by clicking the interactive icon 404, or the like), the GUI 400 can display an informational message 406. The informational message 406 indicates to the user 104 of the client device 102 that the message 402 has been auto forwarded by the server 108 and/or by a different client device 102. The informational message 406 can include text, such as “This message was auto forwarded to enable secure delivery of your package.” The information message 406 may include additional, or alternative, text.

In some examples, the message 402 includes text that indicates a security code 206 to a user 104 for receiving a delivery of a package 202, where the security code 206 and the package 202 are examples of the corresponding features as described with reference to FIG. 2. For example, the text can include “Package is out for delivery. Please share security code (1234) with delivery agent.” The text can be any variation of text that displays the security code 206 (e.g., 1234). The message 402 can request user input from the user 104, such as an acknowledgement of the message 402 (e.g., via buttons). The user 104 can provide the security code 206 to a delivery agent 204, as described with reference to FIG. 2.

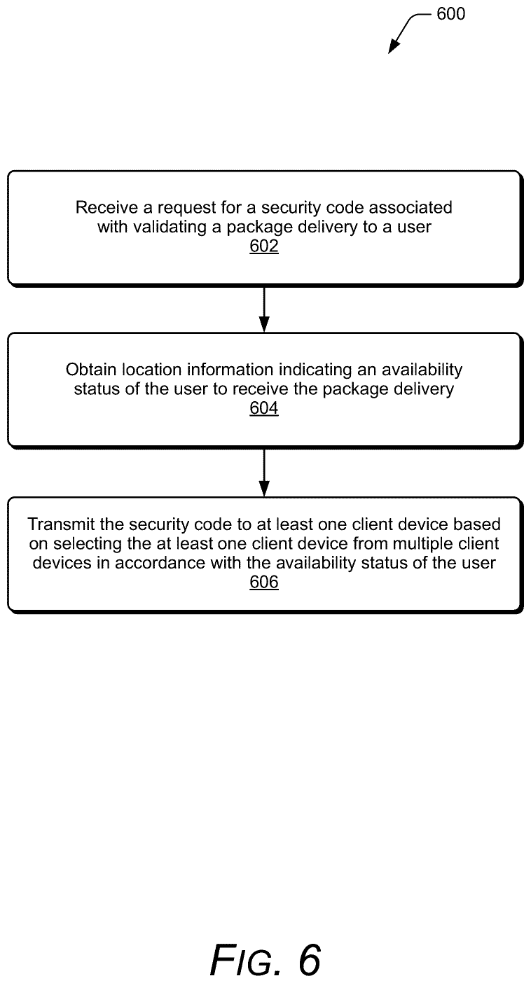

FIG. 5 illustrates an example process flow 500, which supports secure package delivery without a target recipient in accordance with one or more implementations as described herein. The example process flow 500 may implement aspects of the example system 100, as well as any of the example system 200, the GUI 300, or the GUI 400. For example, the example process flow 500 can be implemented by a client device 102 of a target user 104, a client device 102 of an alternate user 104, and/or a server 108, which may be examples of the corresponding features as described with reference to FIGS. 1 through 4. Alternative examples of the following may be implemented, where some processes are performed in a different order than described or are not performed. In some cases, processes may include additional features not mentioned below, or further processes may be added.

At 502, a list of authorized users is generated. The list of authorized users includes users that are authorized or trusted to receive a package delivery for a target user. In some examples, a target user can specify the list of authorized users. In some other examples, the server 108 and/or the client device 102 can determine the list of authorized users without user input, such as by using historical data related to delivery of the packages to the address, application data of the client device 102 of the target user, and/or other system data of the client device 102 of the target user.

At 504, a delivery of a package is initiated. For example, the delivery of the package is initiated when the package is scanned by a delivery agent. In some other cases, the delivery agent can manually initiate the delivery of the package. At 506, a security code for package delivery is obtained by a server 108. The security code can be an example of an OTP or any other security code. The server 108 can generate the security code using code generation techniques (e.g., a random number generator, or the like).

In some examples, a server 108 determines whether a target user is available at 508. The server 108 determines an availability status of the user using location information of a target user and/or one or more alternate users on the list of authorized users. The availability status indicates whether a user is available to receive the package delivery or is unavailable to receive the package delivery. In some examples, the user is available to receive the package delivery if the user is at a physical location for delivery of the package and is not busy during a scheduled delivery window (e.g., in a meeting based on calendar information from a scheduling application at the client device 102, settings of the client device 102 are set to receive communications, etc.). Similarly, the user is not available to receive the package delivery if the user is not at a physical location for delivery of the package and/or is busy during a scheduled delivery window.

In some examples, the location information includes one or more of a geographical location of a user, one or more settings of a client device 102 of a user, or application data from the client device 102 of a user. In some cases, the client device 102 and/or the server 108 receives respective application data from a respective client device 102 for each user on the list of authorized users. Respective availability statuses of the users are determined by analyzing the respective application data. For example, scheduling application data can be analyzed to determine whether the user is occupied in an event. Messaging application data can be analyzed to determine whether the user is traveling. Tracking application data can be analyzed to determine a physical location of the user.

If the server determines the target user is available, then at 510, the security code is transmitted to the client device 102 of the target user. For example, the server 108 transmits the security code in a message for display to the target user of the client device 102. If the server determines the target user is not available, then at 512, one or more authorized users are selected from the list of authorized users. The server 108 can select a single authorized user or can select multiple authorized users from the list of authorized users. For example, the server 108 selects the authorized users with respective availability statuses that indicate the authorized user is available to receive the delivery of the package. Additionally, or alternatively, the client device 102 can make this determination based on receiving the security code from the server 108 and select the authorized user with respective availability statuses to determine an authorized user who can be forwarded the received security code.

At 514, the security code is transmitted to the selected authorized users. For example, the server 108 can transmit the security code to the client devices 102 of the authorized users. The client devices 102 of the authorized users can display the security code to the authorized users via a GUI, as described with reference to FIGS. 3 and 4. At 516, if the security code is transmitted to the target user, a client device 102 receives the security code. The client device 102 can perform an additional analysis of whether the target user is available to receive the delivery of the package. For example, the client device 102 can have access to additional or updated location information when compared with the location information at the server 108.

In some cases, the client device determines whether the target user is available, at 518. For example, the client device 102 analyzes geographic location information (e.g., GPS data), application data, and/or system data of the client device 102 to determine whether the user is available to receive the delivery of the package or is not available to receive the delivery of the package.

At 520, if the target user is not available, an authorized user is selected from a list of authorized users. The list of authorized users can be preconfigured by a user (e.g., via user input) and/or can be determined from historical data, as described at 502. In some cases, the client device 102 selects one authorized user from the list of authorized users. In some other cases, the client device 102 selects multiple authorized users from the list of authorized users. For example, the client device 102 can select the authorized users that are available to receive the delivery of the package.

At 522, the security code is transmitted to the selected authorized user. For example, the client device 102 can transmit the security code to a client device 102 of the selected authorized user for display at the client device 102, as described with reference to FIGS. 3 and 4. In some examples, the client device 102 of the target user can forward the security code to the client devices 102 of the selected authorized users. In some examples, the security code can expire prior to being used by the selected authorized users. Thus, the client devices 102 of the selected authorized users can send a message to the server 108 requesting an additional security code. The server 108 retransmits the security code or transmits a new security code to the client devices 102 of the selected authorized users.

At 524, if the target user is available, a security code is received by the target user for package delivery. Additionally, or alternatively, the security code is received by an alternate user for package delivery. A user who is available at the physical location for the delivery of the package may receive the security code and can coordinate with a delivery agent to receive the delivery of the package.

The example process flow 500, as well as example methods 600 and 700, are described with reference to respective FIGS. 5, 6, and 7 in accordance with one or more implementations of secure package delivery without a target recipient, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

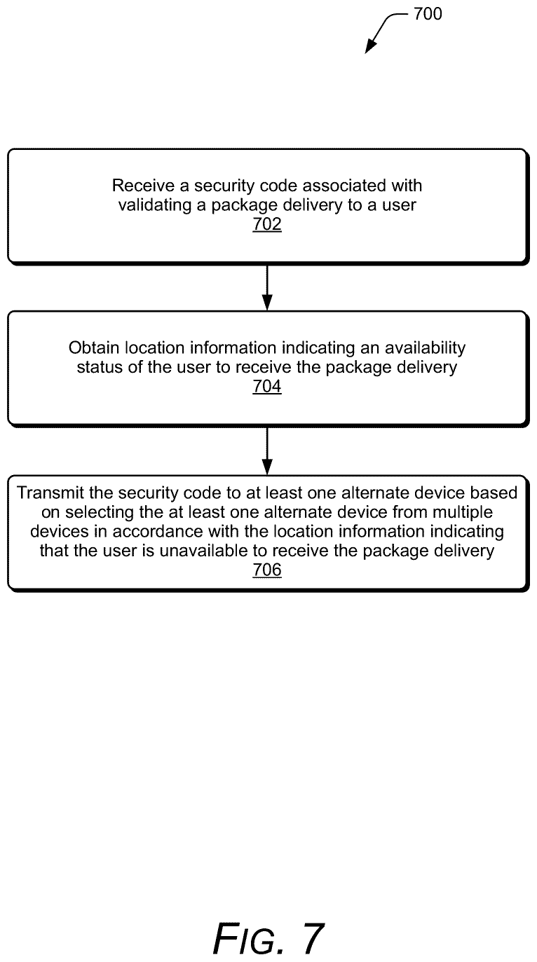

FIG. 6 illustrates one or more example methods 600 for secure package delivery without a target recipient. The order in which the method is described is not intended to be construed as a limitation, and any number or combination of the described method operations can be performed in any order to perform a method, or an alternate method.

At 602, a request for a security code associated with validating a package delivery to a user is received. For example, the security code manager 120 can generate the security code using code generation techniques (e.g., random number generation techniques). At 604, location information indicating an availability status of the user to receive the package delivery is obtained. The location information includes one or more of a geographical location of the user, one or more settings of multiple client devices of users on a list of authorized users, or application data associated with the multiple client devices.

At 606, the security code is transmitted to at least one client device based on selecting the at least one client device from the multiple client devices in accordance with the availability status of the user. In some examples, the multiple client devices are determined based on an indication of the multiple client devices from a user. In some other examples, the multiple client devices are determined based on obtaining historical delivery data corresponding to the multiple client devices. In some cases, the at least one client device is a client device of a target user for delivery of the package based on the availability status of the target user being available to receive the package delivery. In some other cases, the at least one client device is a client device of an alternate user (e.g., not the target user) based on the availability status of the target user being unavailable to receive the package delivery.

In some cases, to select the at least one client device, respective application data from the multiple client devices is received. Respective availability statuses of users of the multiple client devices are based on the respective application data. The multiple client devices correspond to one or more users who are trusted or authorized to receive the package delivery. In some cases, when multiple authorized client devices are determined to be eligible alternate client devices to receive the secure code, there can be a priority order assigned to the authorized user list and/or authorized device list so as to determine which device the secure code is delivered to. In some examples, an additional request for the security code is received. The security code is transmitted to at least one alternate client device of the multiple client devices based on receiving the additional request for the security code.

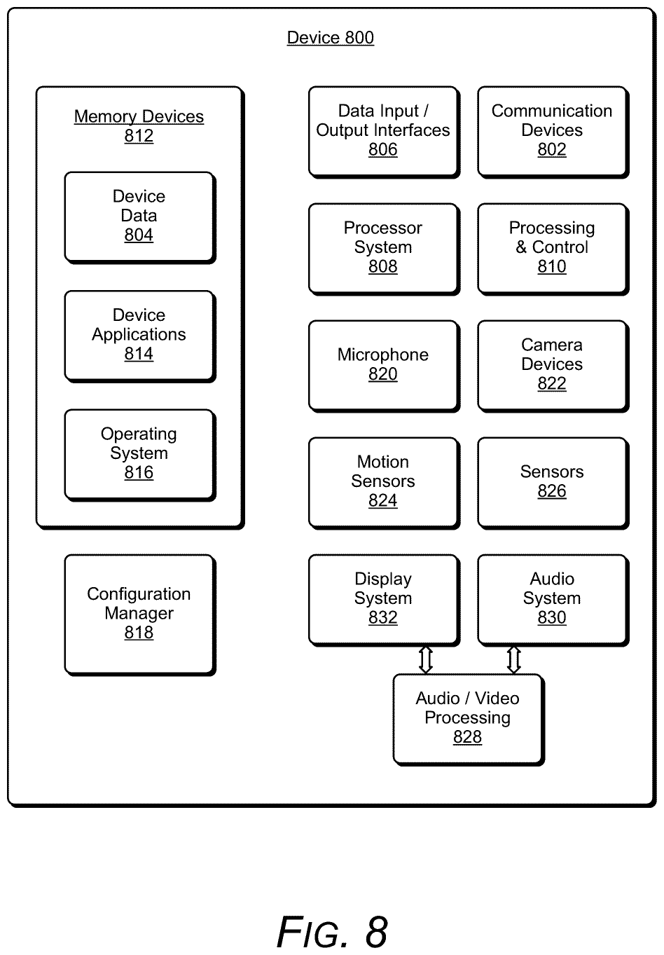

FIG. 7 illustrates one or more example methods 700 for secure package delivery without a target recipient. The order in which the method is described is not intended to be construed as a limitation, and any number or combination of the described method operations can be performed in any order to perform a method, or an alternate method.

At 702, a security code associated with validating a package delivery to a user 104 is received. For example, the communications manager 114 at a client device 102 receives the security code from the server 108. At 704, location information indicating an availability status of the user to receive the package delivery is obtained. For example, the data manager 112 retrieves the location information from a database 106. The location information includes one or more of a geographical location of the user, one or more settings of multiple devices of users on a list of authorized users, or application data associated with the multiple devices.

At 706, the security code is transmitted to at least one alternate device (e.g., a client device 102) based on selecting the at least one alternate device from the multiple devices in accordance with the location information indicating that the user 104 is unavailable to receive the package delivery. For example, the communications manager 114 transmits the security code to the alternate device. In some cases, when multiple authorized client devices are determined to be eligible alternate client devices to receive the secure code, there can be a priority order assigned to the authorized user list and/or authorized device list so as to determine which device the secure code is delivered to. In some examples, user input is obtained that indicates the multiple devices. In some other examples, historical delivery data is obtained that corresponds to the multiple devices. In some cases, to select the at least one alternate device, respective application data is received from the multiple devices. The respective availability statuses of users of the multiple devices are based on the respective application data. The multiple devices correspond to one or more users who are trusted or authorized to receive the package delivery.

FIG. 8 illustrates various components of an example device 800, which can implement aspects of the techniques and features for secure package delivery without a target recipient, as described herein. The example device 800 can be implemented as any of the devices described with reference to the previous FIGS. 1 through 7, such as any type of a wireless device, mobile device (e.g., the client device 102), mobile phone, flip phone, client device, companion device, paired device, display device, tablet, computing, communication, entertainment, gaming, media playback, and/or any other type of computing, consumer, and/or electronic device. For example, the client device 102 described with reference to FIGS. 1 through 7 may be implemented as the example device 800.

The example device 800 can include various, different communication devices 802 that enable wired and/or wireless communication of device data 804 with other devices. The device data 804 can include any of the various device's data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input/output (I/O) interfaces 806, such as data network interfaces that provide connection and/or communication links between the devices, data networks, and other devices. The I/O interfaces 806 can be used to couple the device to any type of components, peripherals, and/or accessory devices, such as a computer input device that may be integrated with the example device 800. The I/O interfaces 806 may also include data input ports via which any type of data, information, media content, communications, messages, and/or inputs can be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified at 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random-access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 can be maintained as software instructions with a memory device 812 and executed by the processor system 808 as a software application. The device applications 814 may also include a device manager, such as any form of a control application, software application, signal processing and control module, code that is specific to a particular device, a hardware abstraction layer for a particular device, and so on.

In this example, the device 800 includes a configuration manager 818 that implements various aspects of the described features and techniques described herein. The configuration manager 818 can be implemented with hardware components and/or in software as one of the device applications 814, such as when the example device 800 is implemented as the client device 102 described with reference to FIGS. 1 through 7. An example of the configuration manager 818 is the data manager 112 and/or the communication manager 114 implemented in the client device 102, such as a software application and/or as hardware components in the wireless device. In implementations, the configuration manager 818 may include independent processing, memory, and logic components as a computing and/or electronic device integrated with the example device 800.

The example device 800 can also include a microphone 820 and/or camera devices 822, as well as proximity and/or motion sensors 824, such as may be implemented as components of an inertial measurement unit (IMU). The proximity and/or motion sensors 824 can be implemented with various sensors, such as a gyroscope, an accelerometer, and/or other types of motion sensors to sense motion of the device. The motion sensors 824 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources 826, such as when the device is implemented as a wireless device and/or a client device 102. The power sources may include a charging and/or power system, and can be implemented as a flexible strip battery, a rechargeable battery, a charged super-capacitor, and/or any other type of active or passive power source.

The example device 800 can also include an audio and/or video processing system 828 that generates audio data for an audio system 830 and/or generates display data for a display system 832. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 800. Alternatively, the audio system and/or the display system are external, peripheral components to the example device.

Although implementations of secure package delivery without a target recipient have been described in language specific to features and/or methods, the appended claims are not necessarily limited to the specific features or methods described. Rather, the specific features and methods are disclosed as example implementations of secure package delivery without a target recipient, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a server device, including: a memory, and at least one processor coupled with the memory and configured to cause the server device to: receive a request for a security code associated with validating a package delivery to a user, obtain location information indicating an availability status of the user to receive the package delivery, and transmit the security code to at least one client device based on selecting the at least one client device from multiple client devices in accordance with the availability status of the user.

In some aspects, the techniques described herein relate to a server device, where the at least one processor is further configured to cause the server device to receive an indication of the multiple client devices, where selecting the at least one client device is based on the indication.

In some aspects, the techniques described herein relate to a server device, where the at least one processor is further configured to cause the server device to obtain historical delivery data corresponding to the multiple client devices, where selecting the at least one client device is based on the historical delivery data.

In some aspects, the techniques described herein relate to a server device, where the at least one client device corresponds to the user based on the availability status of the user being available to receive the package delivery.

In some aspects, the techniques described herein relate to a server device, where the at least one client device corresponds to an alternate user based on the availability status of the user being unavailable to receive the package delivery.

In some aspects, the techniques described herein relate to a server device, where the at least one processor is further configured to cause the server device to: receive an additional request for the security code, and transmit the security code to at least one alternate client device of the multiple client devices based on receiving the additional request for the security code.

In some aspects, the techniques described herein relate to a server device, where to select the at least one client device, the at least one processor is further configured to cause the server device to receive respective application data from the multiple client devices, where respective availability statuses of users of the multiple client devices are based on the respective application data.

In some aspects, the techniques described herein relate to a server device, where the multiple client devices correspond to one or more users who are authorized to receive the package delivery.

In some aspects, the techniques described herein relate to a server device, where the location information includes one or more of a geographical location of the user, one or more settings of the multiple client devices, or application data associated with the multiple client devices.

In some aspects, the techniques described herein relate to a mobile device, including: a memory, and at least one processor coupled with the memory and configured to cause the mobile device to: receive a security code associated with validating a package delivery to a user, obtain location information indicating an availability status of the user to receive the package delivery, and transmit the security code to at least one alternate device based on selecting the at least one alternate device from multiple devices in accordance with the location information indicating that the user is unavailable to receive the package delivery.

In some aspects, the techniques described herein relate to a mobile device, where the at least one processor is further configured to cause the mobile device to obtain user input indicating the multiple devices, where selecting the at least one alternate device is based on the user input.

In some aspects, the techniques described herein relate to a mobile device, where the at least one processor is further configured to cause the mobile device to obtain historical delivery data corresponding to the multiple devices, where selecting the at least one alternate device is based on the historical delivery data.

In some aspects, the techniques described herein relate to a mobile device, where to select the at least one alternate device, the at least one processor is further configured to cause the mobile device to receive respective application data from the multiple devices, where respective availability statuses of users of the multiple devices are based on the respective application data.

In some aspects, the techniques described herein relate to a mobile device, where the multiple devices correspond to one or more users who are authorized to receive the package delivery.

In some aspects, the techniques described herein relate to a mobile device, where the location information includes one or more of a geographical location of the user, one or more settings of the multiple devices, or application data associated with the multiple devices.

In some aspects, the techniques described herein relate to a method including: receiving a request for a security code associated with validating a package delivery to a user, obtaining location information indicating an availability status of the user to receive the package delivery, and transmitting the security code to at least one client device based on selecting the at least one client device from multiple client devices in accordance with the availability status of the user.

In some aspects, the techniques described herein relate to a method, further including receiving an indication of the multiple client devices, where selecting the at least one client device is based on the indication.

In some aspects, the techniques described herein relate to a method, further including obtaining historical delivery data corresponding to the multiple client devices, where selecting the at least one client device is based on the historical delivery data.

In some aspects, the techniques described herein relate to a method, where the at least one client device corresponds to the user based on the availability status of the user being available to receive the package delivery.

In some aspects, the techniques described herein relate to a method, where the at least one client device corresponds to an alternate user based on the availability status of the user being unavailable to receive the package delivery.

1. A server device, comprising:
a memory; and
at least one processor coupled with the memory and configured to cause the server device to:
receive a request for a security code associated with validating a package delivery to a user;
obtain location information associated with a client device and an indication of a capability of the client device to receive a notification, wherein the location information and the indication of the capability correspond to an availability status of the user to receive the package delivery;
select, based on the availability status of the user and respective availability statuses of users of multiple client devices, at least one client device from the multiple client devices; and
transmit the security code to the at least one client device to validate the package delivery to the user.

2. The server device of claim 1, wherein the at least one processor is further configured to cause the server device to receive an indication of the multiple client devices, wherein selecting the at least one client device is based on the indication.

3. The server device of claim 1, wherein the at least one processor is further configured to cause the server device to obtain historical delivery data corresponding to the multiple client devices, wherein selecting the at least one client device is based on the historical delivery data.

4. The server device of claim 1, wherein the at least one client device corresponds to the user based on the availability status of the user being available to receive the package delivery.

5. The server device of claim 1, wherein the at least one client device corresponds to an alternate user based on the availability status of the user being unavailable to receive the package delivery.

6. The server device of claim 1, wherein the at least one processor is further configured to cause the server device to:
receive an additional request for the security code; and
transmit the security code to at least one alternate client device of the multiple client devices based on receiving the additional request for the security code.

7. The server device of claim 1, wherein to select the at least one client device, the at least one processor is further configured to cause the server device to receive respective application data from the multiple client devices, wherein respective availability statuses of users of the multiple client devices are based on the respective application data.

8. The server device of claim 1, wherein the multiple client devices correspond to one or more users who are authorized to receive the package delivery.

9. The server device of claim 1, wherein the location information includes one or more of a geographical location of the user, one or more settings of the multiple client devices, or application data associated with the multiple client devices.

10. A mobile device, comprising:
a memory; and
at least one processor coupled with the memory and configured to cause the mobile device to:
receive a security code associated with validating a package delivery to a user;
obtain location information associated with the mobile device and an indication of a capability of the mobile device to receive a notification, wherein the location information and the indication of the capability correspond to an availability status of the user to receive the package delivery;
select, based on the availability status of the user and respective availability statuses of users of multiple devices, at least one alternate device from the multiple devices; and
transmit the security code to the at least one alternate device to validate the package delivery to the user.

11. The mobile device of claim 10, wherein the at least one processor is further configured to cause the mobile device to obtain user input indicating the multiple devices, wherein selecting the at least one alternate device is based on the user input.

12. The mobile device of claim 10, wherein the at least one processor is further configured to cause the mobile device to obtain historical delivery data corresponding to the multiple devices, wherein selecting the at least one alternate device is based on the historical delivery data.

13. The mobile device of claim 10, wherein to select the at least one alternate device, the at least one processor is further configured to cause the mobile device to receive respective application data from the multiple devices, wherein respective availability statuses of users of the multiple devices are based on the respective application data.

14. The mobile device of claim 10, wherein the multiple devices correspond to one or more users who are authorized to receive the package delivery.

15. The mobile device of claim 10, wherein the location information includes one or more of a geographical location of the user, one or more settings of the multiple devices, or application data associated with the multiple devices.

16. A method comprising:
receiving a request for a security code associated with validating a package delivery to a user;
obtaining location information associated with a client device and an indication of a capability of the client device to receive a notification, wherein the location information and the indication of the capability correspond to an availability status of the user to receive the package delivery;
select, based on the availability status of the user and respective availability statuses of users of multiple client devices, at least one client device from the multiple client devices; and
transmitting the security code to the at least one client device to validate the package delivery to the user.

17. The method of claim 16, further comprising receiving an indication of the multiple client devices, wherein selecting the at least one client device is based on the indication.

18. The method of claim 16, further comprising obtaining historical delivery data corresponding to the multiple client devices, wherein selecting the at least one client device is based on the historical delivery data.

19. The method of claim 16, wherein the at least one client device corresponds to the user based on the availability status of the user being available to receive the package delivery.

20. The method of claim 16, wherein the at least one client device corresponds to an alternate user based on the availability status of the user being unavailable to receive the package delivery.
